(19) United States
(12) Patent Application Publication
(10) Pub. No.: US 2022/0270148 A1
(43) Pub. Date: Aug. 25, 2022

(54) SYSTEM AND METHOD FOR IN STORE REQUEST ASSISTANCE

(71) Applicant: Toshiba TEC Kabushiki Kaisha, Shinagawa-ku (JP)

(72) Inventors: Ngoc NGUYEN, Santa Ana, CA (US); William TANG, Covina, CA (US)

(21) Appl. No.: 17/184,241

(22) Filed: Feb. 24, 2021

(51) Int. Cl. G06Q 30/06; G06Q 10/06; G06Q 30/02; G06F 40/174

(52) U.S. Cl. CPC G06Q 30/0613; G06Q 10/06311; G06Q 10/06316; G06Q 30/0281; G06F 40/174

(57) ABSTRACT

A service request assistance system. A service request server includes a processor, a network interface, and memory, the processor having executable instructions to facilitate wireless data communication through the network interface with a plurality of customer handheld data devices and a plurality of employee handheld data devices. Each of the plurality of the customer handheld data devices includes a customer device processor running a customer device application. Each of the plurality of the employee handheld data devices includes an employee device processor running an employee application. The processor is configured to receive a plurality of customer requests. The processor is configured to distribute the plurality of customer requests to a plurality of employee handheld data devices, each of the plurality of employee handheld data devices displaying a request queue, the request queue being a visual representation of the plurality of customer requests.

### TECHNICAL FIELD

This application relates generally to systems and methods of customer service in retail stores.

### BACKGROUND

Customers in retail stores often have questions about the store, its products, and its services. Often a store representative is not readily available to help a customer.

### BRIEF DESCRIPTION OF THE DRAWINGS

Various embodiments will become better understood with regard to the following description, appended claims and accompanying drawings wherein:

FIG. 1 is an example embodiment of a system for an in-store request assistance system;

FIG. 2 is an example embodiment of a screen display on handheld data device;

FIG. 3 is an example embodiment of a screen display on handheld data device;

FIG. 4 is an example embodiment of a screen display on handheld data device;

FIG. 5 is an example embodiment of a screen display on handheld data device;

FIG. 6 is an example embodiment of a screen display on handheld data device;

FIG. 7 is an example embodiment of a screen display on handheld data device;

FIG. 8 is an example embodiment of a networked digital device such as a handheld data device; and

FIG. 9 is an example embodiment of a digital device system such as a handheld data device.

### DETAILED DESCRIPTION

The systems and methods disclosed herein are described in detail by way of examples and with reference to the figures. It will be appreciated that modifications to disclosed and described examples, arrangements, configurations, components, elements, apparatuses, devices methods, systems, etc. can suitably be made and may be desired for a specific application. In this disclosure, any identification of specific techniques, arrangements, etc. are either related to a specific example presented or are merely a general description of such a technique, arrangement, etc. Identifications of specific details or examples are not intended to be, and should not be, construed as mandatory or limiting unless specifically designated as such.

An in-store request assistance system is connected in data communication with a service request server. The service request server can include a processor and memory, including executable instructions to receive, store, and process store information including a store inventory, location of retail items, store personnel and related data communication to and from wireless handheld devices. Customer requests, employee responses, and all system data transmission is achieved by executable instructions in the processor acting on customer and employee inputs and actions. As used herein, unless otherwise noted, “user” and “customer” are used interchangeably, with both terms referring to the person(s) using the in-store request assistance system according to the description herein. As used herein “store resources,” “store employees,” “store associates,” and “employees,” are used interchangeably, being terms used to describe those in an in-store environment paid to assist customers in some manner. The terms can refer to employees that are physically in the store, as well as employees located remotely. The terms also refers to employees whether they are, at the time of the operation of the system, “on the clock.”

The in-store request assistance system can facilitate a better user experience by using a web service to filter incoming customer requests and provides a notification of customer requests to store employees. In an example embodiment customer requests submitted by a customer's handheld data device can be distributed to a predetermined plurality of employee resources in the retail store, including all available employees, to provide more timely help to the customers.

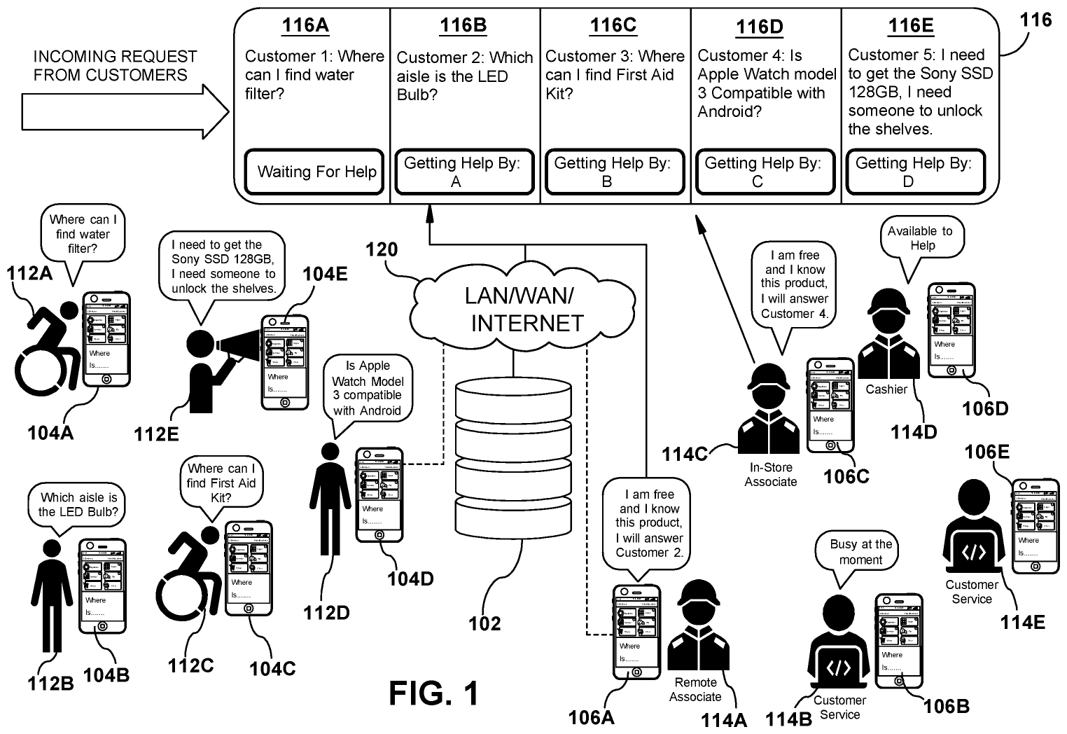

FIG. 1 illustrates an example embodiment of an in-store request assistance system 100. A service request server 102 and at least one customer handheld data device 104 and at least one employee handheld device 106 can be in mutual data communication by network cloud 120, suitably comprised of a local area network (LAN), wide area network (WAN) which may comprise the Internet, or any combination thereof. Network connectivity is provided by any suitable wireless or wired technology. Operation of example embodiments disclosed herein are operable solely within a LAN or subnet. WAN or Internet connectivity is not required.

In the example embodiment of FIG. 1, the service request server 102 is operable as a processor and memory for facilitating a method of using the in-store request assistance system 100. Customers 112 can interact with the service request server 102 by using an application, also known as an “app,” or equivalent on their respective customer handheld data devices 104. The customer handheld data device 104 can be a smartphone, but it can also be any suitable data device, such as a notebook computer, tablet computer, and the like, wirelessly connected to the in-store request assistance system 100. In an embodiment, a customer downloads the required app onto their own customer handheld data device 104. In an embodiment, a handheld data device is provided to the customer upon entering the store, to be used while in the store, and returned prior to leaving the store. In an embodiment, the handheld data device is a dedicated device configured to operate one or a limited number of apps, including the app to utilize the in-store request assistance system 100. Store employees 114 can interact with the service request server 102 by similarly utilizing an “app” or equivalent on their respective employee handheld data devices 106. The employee handheld device 106 can be a smartphone, but it can also be any suitable data device, such as a notebook computer, tablet computer, and the like, wirelessly connected to the in-store request assistance system 100.

A customer 112 can use his customer handheld data device 104 to enter and send a request for help, which can include requests such as locating a particular retail item, requests for technical support, and general requests for store services. The customer request is suitably sent to the service request server 102 and routed to a request queue 116 in the in-store request assistance system 100. For example, as shown in FIG. 1, a plurality of customers 112, represented as customers 112A-112E can each request assistance via their respective customer handheld devices 104A-104E, each of which are wirelessly in communication via an installed app with the in-store request assistance system 100. Customer 112A can request, “Where can I find a water filter?” and the request can queued in the request queue 116 in a predetermined order, such as “first in, first out.” In the illustrated diagram, requests enter the queue from left to right, such that the request of customer 112A, being the latest request to enter the queue is shown in block 116A, and is indicated in this example as “waiting for help.”

Requests for customer help are routed by the service request server to one or more of store employees 114. In an embodiment certain requests, as determined by suitable filters in the service request server, are sent to specific store employees 114, including all store employees 114. In an embodiment, as illustrated in FIG. 1, every customer request is routed to be received by every store employee 114, so that every employee receives the queued list of requests, and can respond with help to any of the requests in the queued list of requests.

As illustrated in the representative example of FIG. 1, five customers 112 have utilized the app on their respective customer handheld data devices 104 to request help via the in-store request assistance system 100. Specifically, customer 112E was the first to make a requesting in the current request queue 116, and her request is represented in block 116E. Store employee 114E, who may be a customer service representative, sees the notification of the request of customer 112E, and responds with a response to the system. Until the request is completed, the request shows in the queue at block 116E as “getting help by employee 114E” so that other store employees can ignore the request, or offer additional help. At this time, the notification at block 116A of the request queue 116 has not been responded to, and shows an appropriate pending message, such as “waiting for help.”

Similarly, as indicated in the example diagram of FIG. 1, customer 112D can request help such as “Is Apple watch model 3 compatible with Android?” and store employee 114D, who may be a cashier, can respond, such that the notification at block 116D of the request queue 116 will change to an appropriate message, such as “being served by employee 114D.” By further example, customer 112C can request help such as “Where can I find a first aid kit?” and store employee 114C, who may be in-store associate, can respond, such that the notification at block 116C of the request queue 116 will change to an appropriate message, such as “being served by employee 114C.” Customer 112B can request help such as “Which aisle is LED bulb?” and store employee 114A, who may be a remotely located associate, can respond, such that the notification at block 116B of the request queue 116 will change to an appropriate message, such as “being served by employee 114B.”

As can be understood, in an embodiment, the in-store request assistance system 100 links via a server interface customer requests with employee resources, processed as described herein by executable instructions in the processor. Each customer request is distributed to any or all store employees, such that each store employee has the opportunity to respond to any customer request based on time availability and expertise in the specific request. Each customer request is displayed on the employee's handheld data devices. The displayed requests can be shown in a diagrammatic queue, and store employees' responses to each request can be indicated with appropriate messages to indicate the customer request has been responded to. Other employees can then ignore the responded-to requests, or they can offer additional assistance. Once a customer request has been fulfilled, the customer request is removed from the queue.

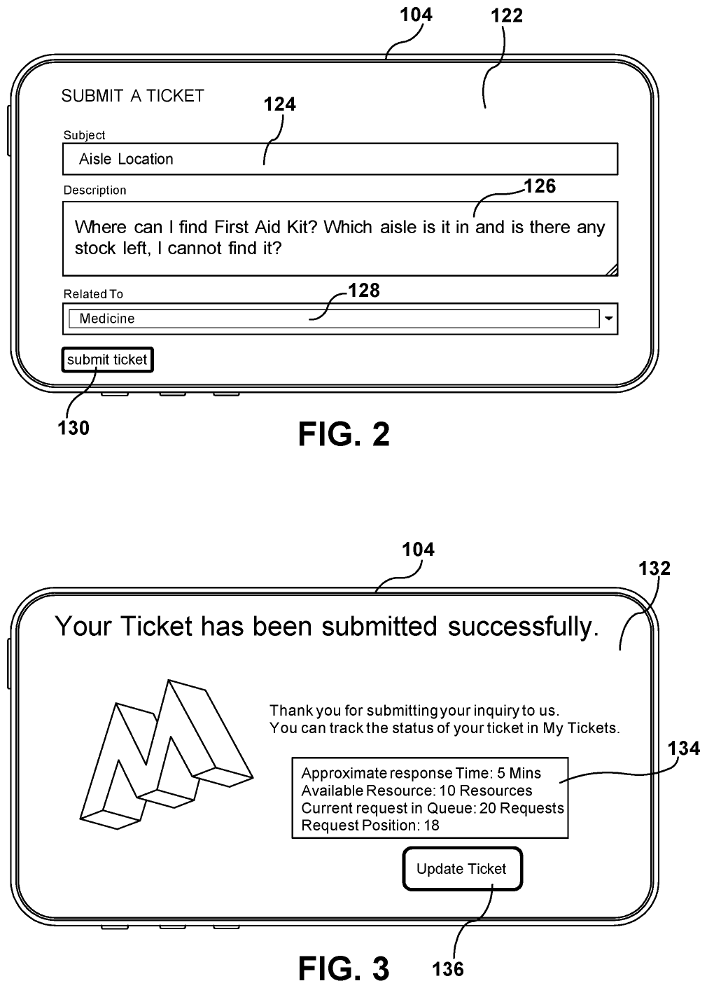

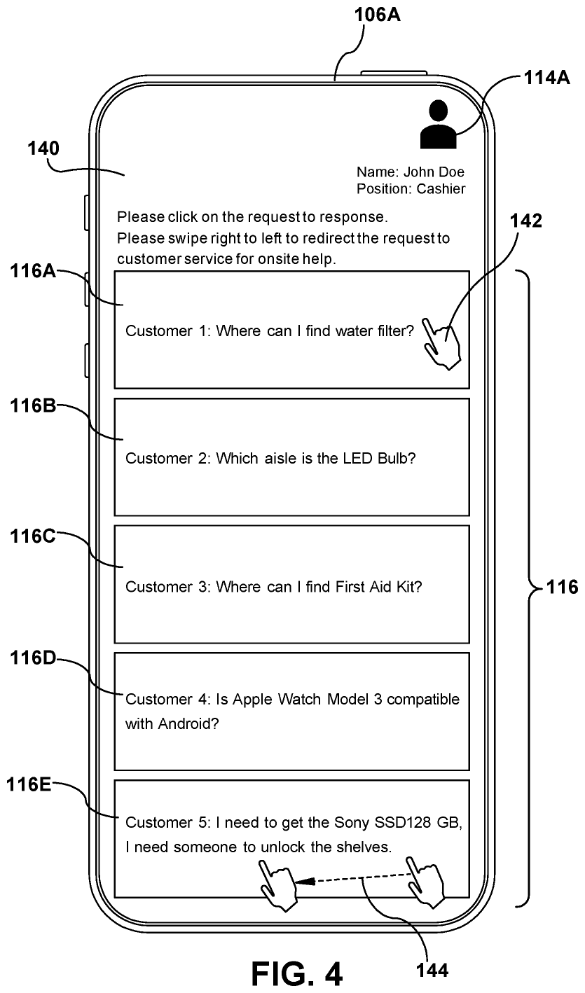

An example method of use of the in-store request assistance system 100, is described with reference to FIGS. 4-7. As shown at FIG. 2, a customer utilizes her customer handheld data device 104 to submit a request, which can be submitted as a “ticket.” A customer-facing app installed and operating on the customer handheld data device 104 presents a screen display 122, on which several system-specific fields are available for entry of data by the customer. For example a “Subject” field 124 can be filled in by the customer with information such as “Aisle information.” A “Description” field 126 can be filled in by the customer with information relating to a specific request. A “Related To” field 128 can be used to provide additional information useful in fulfilling the customer request. A “Submit Ticket” selectable feature 130, when selected, sends the request, via the service request server 102, to the request queue 116. Other fillable fields can be configured as desired.

Once a request for help has been submitted by a customer, the customer can receive on his or her customer handheld data device 104 a confirmation message screen 132 having displayed thereon information relating to the customer request. For example, a request status field 134 can supply information about the customer request, including an approximate response time, number of requests in the system, and the like. If the customer desires to update her request, she can do so by selecting the “Update Ticket” selectable feature that takes the customer to a portion of the app where updates can be entered.

As shown at FIG. 4, a store employee or related resource, whether in the store or remotely located, can view one or more customer requests via an employee-facing app installed and operating on the employee handheld data device 106. The employee-facing app can present a screen display 140, on which employee information can be presented as well as several system-specific fields available for response from the employee. For example the request queue 116 appears on the display, and as depicted in FIG. 3, shows the requests at blocks 116A-116E displayed, which can be referred to generally as request 116N. Any employee to whom the requests 116N are displayed can respond by selecting, including by touching, swiping, clicking, or otherwise choosing one of the requests. In an embodiment, an employee can fulfill the request, he or she can do so by sending a fulfillment signal by touching, or “clicking” on the request 116N, and thus signifying that he or she can respond to the request, as indicated at 142. Thus, by “clicking” on one of the requests 116N, the employee handheld data device 106 sends a message via the service request server to the employee handheld data devices 106 of all the participating employees that a certain employee is providing help to a customer for that request. In an embodiment, selecting to fulfill a request 116N removes the request 116N from the request queue 116. In an embodiment, if a given employee cannot help a customer request, he can indicate by interacting with the requests in the queue, such as by swiping to the right or left, as indicated at 144. In an embodiment, swiping to the right or left on a request 116N sends the request to an on-site help desk for review by a sub-set of store resources.

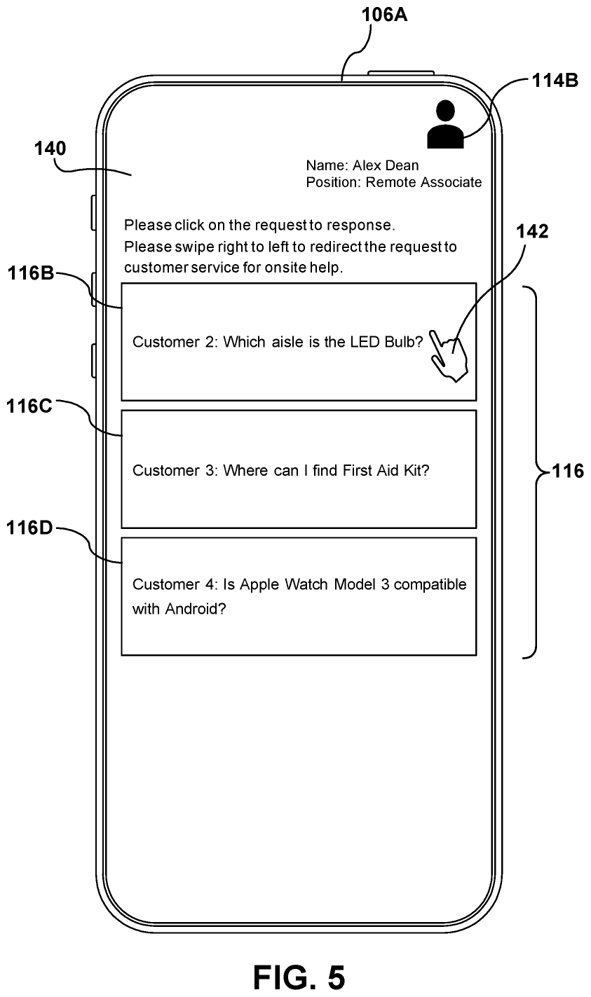

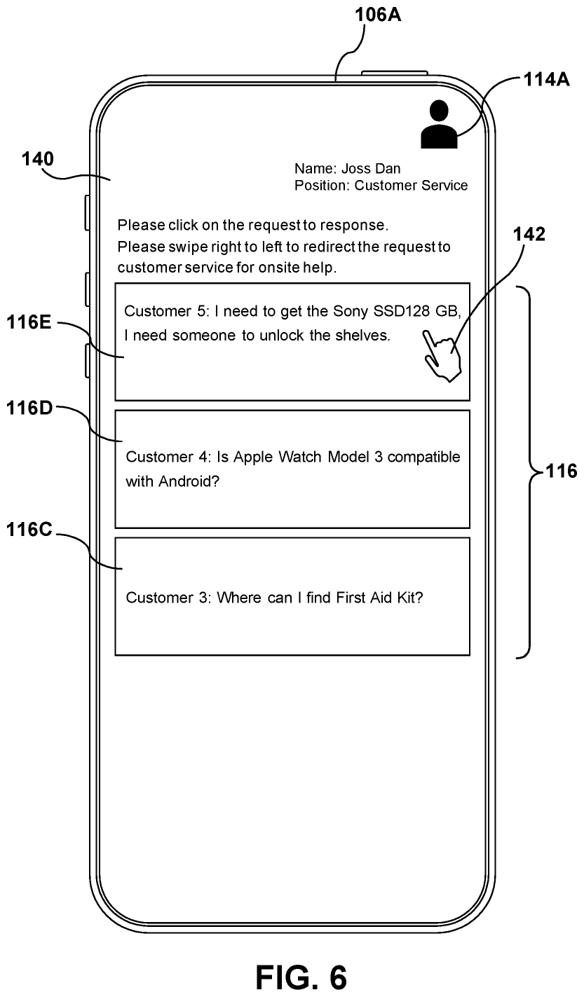

In the representative example of FIGS. 4-6, a first employee, such as store employee 114A of FIG. 1, responds by touching 142 the request 116A and swiping 144 the request 116E. Thus, as indicated at FIG. 5, the employee handheld data device 106 of a second employee, such as employee 114B, shows on its screen display 140 only three remaining requests in the request queue 116: request 116B, request 116C, and request 116D. The second store employee 114B can select to fulfill a request, such as by touching 142 request 116B. Other employees then see on the screen display 140 of their respective employee handheld data devices 106 the remaining request queue 116, as indicated in FIG. 6. For example, the first store employee 114A can see on the screen display 140 of his employee handheld data device 106A three remaining requests: request 116C, request 116D, and request 116E with is placed back in the request queue 116. In the example of FIG. 6, first employee 114A can now select to fulfill the request 116E.

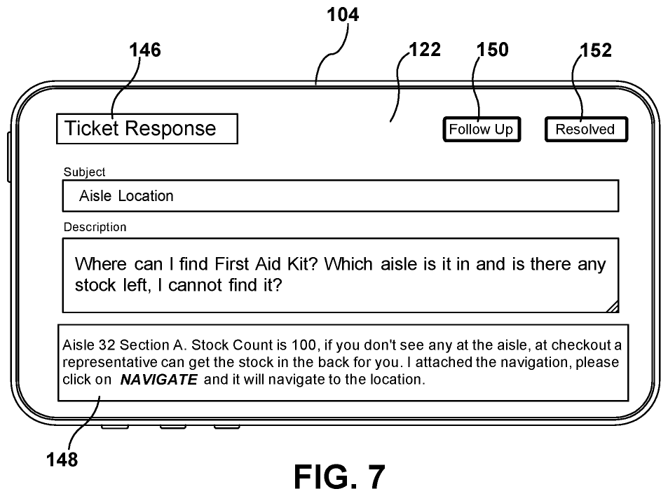

A request fulfillment by any store employee is received as a response to the customer request by the customer on his or her customer handheld data device, as indicated by the example screen display 122 of the customer handheld data device 104 shown in FIG. 7. The response can be labeled as such, for example as a “ticket response” 146, and the response can be shown in a response field 148. At this time the customer can continue with a modified or additional request by selecting a follow-up selectable feature 150. Alternatively, the customer can indicate that the request is satisfied by selecting a resolved selectable feature 152.

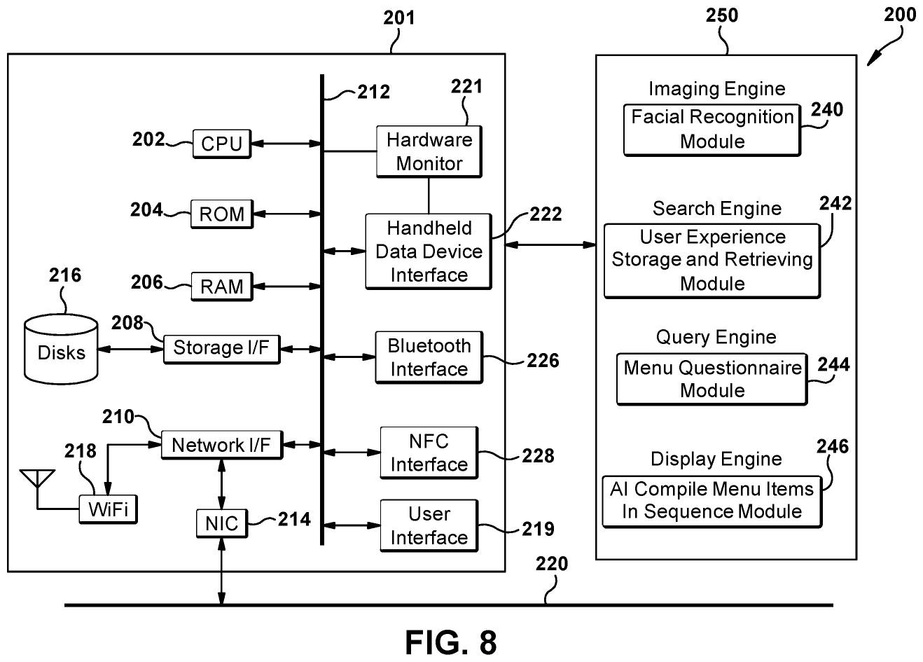

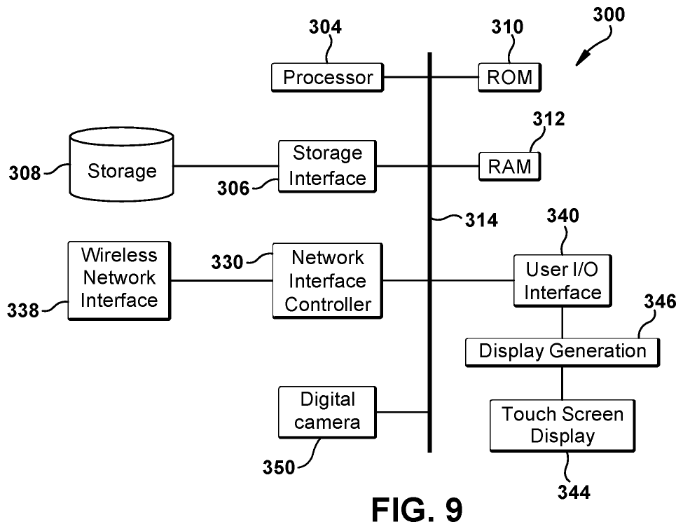

The plurality of handheld data devices disclosed herein can each be suitable for data communication with components of the in-store request assistance system 100. Turning now to FIG. 8 illustrated is an example portion of the in-store request assistance system 100, including the portion comprising the components 200 suitably comprised within a handheld data devices 104 and 106 of FIG. 1. It will be appreciated that the in-store request assistance system 100 includes a controller 201 which is itself a computer system, and can be suitably comprised within the service request server 102. Included in controller 201 are one or more processors, such as that illustrated by processor 202. Each processor is suitably associated with non-volatile memory, such as read only memory (ROM) 204, and random access memory (RAM) 206, via a data bus 212.

Processor 202 can also be in data communication with a storage interface 208 for reading or writing data with storage 216, suitably comprised of a hard disk, optical disk, solid-state disk, cloud-based storage, or any other suitable data storage as will be appreciated by one of ordinary skill in the art.

Processor 202 can also be in data communication with a network interface 210 which provides an interface to a network interface controller (NIC) 214, which in turn provides a data path to any suitable wired or physical network connection 220, or to a wireless data connection via a wireless network interface, such as Wi-Fi 218. Example wireless connections include cellular, Wi-Fi, wireless universal serial bus (wireless USB), satellite, and the like. Example wired interfaces include Ethernet, USB, IEEE 1394 (FireWire), Lightning, telephone line, or the like. Processor 202 is also in data communication with a hardware monitor 221, suitably amassing state data from subassemblies, sensors, digital thermometers, or the like, and suitably including digital state date including device codes, such as device error codes. Processor 202 can also be in data communication with a handheld data device interface 222, with Bluetooth interface 226 and NFC interface 228 via data bus 212.

Processor 202 can also be in data communication with any suitable user input/output (I/0) interface (not shown) which provides data communication with user peripherals, such as displays, keyboards, mice, track balls, touch screens, or the like.

Handheld data device interface 222 is suitable for data communication with components of the handheld data devices 104 and 106. In the illustrated example, these components include an imaging engine, suitably comprised of digital camera hardware including a facial recognition module 240, a search engine, suitably comprised of search and retrieval hardware a storage and retrieving module 242, a query engine, suitably comprised of a user-interactive hardware for a request questionnaire module 244, and a display engine, suitably comprised of customizable, including artificial intelligence produced, request items in sequence module 246. It will be understood that functional units are suitably comprised of intelligent units, including any suitable hardware or software platform.

Turning now to FIG. 3, illustrated is an example of a digital device system 300 suitably comprising the handheld data devices 104 and 106 of FIG. 1. Included are one or more processors, such as that illustrated by processor 304. Each processor is suitably associated with non-volatile memory, such as read only memory (ROM) 310 and random access memory (RAM) 312, via a data bus 314.

Processor 304 is also in data communication with a storage interface 306 for reading or writing to a data storage system 308, suitably comprised of a hard disk, optical disk, solid-state disk, or any other suitable data storage as will be appreciated by one of ordinary skill in the art.

Processor 304 is also in data communication with a network interface controller (NIC) 330, which provides a data path to any suitable network or device connection, such as a suitable wireless data connection via wireless network interface 338. A suitable data connection to an 1VIF P or server is via a data network, such as a local area network (LAN), a wide area network (WAN), which may comprise the Internet, or any suitable combination thereof. A digital data connection is also suitably made with the reservation system 102, such as via Bluetooth, optical data transfer, Wi-Fi direct, or the like.

Processor 304 is also in data communication with a user input/output (I/0) interface 340 which provides data communication with user peripherals, such as touch screen display 344 via display generator 346, as well as keyboards, mice, track balls, touch screens, or the like. It will be understood that functional units are suitably comprised of intelligent units, including any suitable hardware or software platform.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the spirit and scope of the inventions.

1. A service request assistance system, comprising:
a service request server comprising a processor, a network interface, and memory, the processor having executable instructions to facilitate wireless data communication through the network interface with a plurality of customer handheld data devices and a plurality of employee handheld data devices, wherein,
each of the plurality of customer handheld data devices includes a customer device processor running a customer device application,
each of the plurality of employee handheld data devices includes an employee device processor running an employee device application,
the processor configured to receive a plurality of customer requests, including a first customer request from a first handheld data device at a first time and a second customer request from a second handheld data device at a second time, after the first time, each of the plurality of customer requests being received via the network interface;
the processor configured to selectively distribute the plurality of customer requests, including the first customer request and the second customer request to the plurality of employee handheld data devices in accordance with, a position of an employee associated therewith, each of the plurality of employee handheld data devices displaying a request queue, the request queue being a visual representation, the visual representation comprising all or some of the plurality of customer requests displayed and ordered In accordance with the employee associated therewith:
the processor configured to receive a first employee response to one of the first customer request and the second customer request and a second employee response to the other of the first customer request and the second customer request.

2. The service request assistance system of claim 1, wherein a first employee handheld data device displays a portion of the plurality of customer requests in a first ordering associated with a position of a user of the first employee handheld device and wherein a second employee handheld device displays a portion of the plurality of customer requests in a second ordering associated with a position of a user of the second employee handheld device.

3. The service request assistance system of claim 1, wherein the first handheld data device is a smartphone

4. The service request assistance system of claim 1, wherein the customer device application comprises fillable fields, including a field in which to fill in a request for service.

5. The service request assistance system of claim 1, wherein the customer device application comprises a notification of an approximate time to fill a submitted request.

6. The service request assistance system of claim I, wherein the visual representation further comprises an image of the request queue.

7. The service request assistance system of claim 6, wherein the request queue comprises a selectable feature for each of the plurality of customer requests.

8. The service request assistance system of claim 1 wherein the first handheld data device is a dedicated system device.

9. A method comprising:
in a service request system for providing service to customers in a store from employees of the store, the service request system including a service request server, the serv ice request server including a processor and memory and being in data communication through a network interface with a plurality of customer handheld data devices and a plurality of employee handheld data devices including,
receiving, by the service request server, from a first customer handheld data device, a first request for service;
selectively sending, by the service request server, to the plurality of employee handheld data devices in accordance with a position of an associated handheld data device user, the first request for service;
receiving, by the service request server, from a second customer handheld data device, a second request for service;
selectively sending, by the service request server, to the plurality of employee handheld data devices in accordance with the position of an employee associated handheld data device, the second request for service, the first request for service and the second request for service being displayed on each of the plurality of employee handheld data devices in a request in an order corresponding to in accordance with the position of the associated handheld data device user.

10. The method of claim 9 wherein the first customer handheld data device is a wireless device comprising the data communication via a wide area network.

11. The method of claim 9, wherein the first customer handheld data device comprises a touch screen display.

12. The method of claim 9, further comprising sending, by the service request server, to the first customer handheld data device, an approximate wait time for services.

13. (canceled)

14. The method of claim 9, further comprising sending, by the service request server, to the first customer handheld data device, a message responding to the first request for service.

15. A service request assistance system, comprising:
a service request server comprising a processor, a network interface, and memory, the processor having executable instructions to facilitate wireless data communication through the network interface with a plurality of customer handheld data devices and a plurality of employee handheld data devices, wherein,
each of the plurality of customer handheld data devices includes a first customer device processor running a first customer device application,
each of the plurality of employee handheld data devices includes an employee device processor running an employee device application,
the processor configured to receive a plurality of customer requests, including a first customer request from a first customer handheld data device application on a first customer handheld data device at a first time, and a second customer request from a second customer handheld data device application on a second customer handheld data device at a second time, the second time being after the first time, each of the plurality of customer requests being received via the network interface;
the processor configured to selectively distribute the plurality of customer requests, including the first customer request and the second customer request in accordance with an associated employee position, in an order received to the plurality of employee handheld data devices, each of the plurality of employee handheld data devices displaying a request queue in an ordering corresponding to the associated employee position, the request queue being a visual representation of the plurality of customer requests;
the processor configured to receive a first employee response to one of the first customer request and the second customer request, and a second employee response to the other of the first customer request and the second customer request; and,
wherein the first employee response is a response to the first customer request and the second employee response is a referral to other employee resources.

16. The service request assistance system of claim 15, wherein the first customer handheld data device is a wireless device comprising data communication via a wide area network.

17. The service request assistance system of claim 15, wherein the first customer handheld data device is a smartphone.

18. The service request assistance system of claim 15, wherein the first customer handheld data device displays fillable fields, including a field in which to fill in a request for service.

19. The service request assistance system of claim 15, wherein the first customer handheld data device displays a notification of an approximate time to fill a submitted request.

20. The service request assistance system of claim 15, wherein the visual representation further comprises an image of the request queue.
